(19) United States
(12) Patent Application Publication
(10) Pub. No.: US 2025/0340085 A1
(43) Pub. Date: Nov. 6, 2025

(54) PAINT PAIL LINER DEVICE

(71) Applicant: Rachel Tegtmeier, Washington, KS (US)

(72) Inventor: Rachel Tegtmeier, Washington, KS (US)

(21) Appl. No.: 19/049,587

(22) Filed: Feb. 10, 2025

Related U.S. Application Data
(60) Provisional application No. 63/641,137, filed on May 1, 2024.

(51) Int. Cl. B44D 3/12

(52) U.S. Cl. CPC B44D 3/12

(57) ABSTRACT

A paint pail liner device is provided. The device is comprised of an improved paint pail liner comprising a flexible, durable silicone material with a non-stick coating to minimize paint adhesion and simplify cleaning. The liner body includes a molded lip for a secure fit around the pail rim, featuring an overhang to catch drips and optional pour spouts for controlled paint pouring. Integrated handle-shaped cutouts provide reinforced grip points for easy removal, while textured ridges on the interior surface facilitate uniform paint distribution across paint rollers. During use, the flexibility of the liner prevents cracking, supports extended use, and allows it to be turned inside out for thorough cleaning.

### CROSS-REFERENCE TO RELATED APPLICATION

The present application claims priority to, and the benefit of, U.S. Provisional Application No. 63/641,137, which was filed on May 1, 2024, and is incorporated herein by reference in its entirety.

### FIELD OF THE INVENTION

The present invention relates generally to the field of paint container liners. More specifically, the present invention relates to a paint pail liner device that is reusable and can be easily cleaned. Accordingly, the present disclosure makes specific reference thereto. Nonetheless, it is to be appreciated that aspects of the present invention are also equally applicable to other like applications, devices, and methods of manufacture.

### BACKGROUND

Paint pail liners are commonly used to protect the interior of paint pails, prevent paint contamination, and simplify the cleanup process. However, traditional paint pail liners often lack sufficient durability and flexibility, which can lead to frequent replacement and increased material waste. Many existing liners are made from rigid or thin materials that are prone to cracking, tearing, or collapsing during use, especially when subjected to repeated handling or exposure to solvents. Additionally, paint adhesion to the interior surface of these liners can cause significant cleanup challenges, requiring excessive scrubbing or disposal after a single use. This inefficiency adds time and cost to painting projects for both professional painters and DIY users. Moreover, conventional liners typically do not incorporate design features that enhance the usability of the liner, such as secure fits, drip control, or functional compartments for tools and accessories. These limitations reduce the overall convenience and functionality of the liner during paint application, particularly when working in fast-paced or large-scale environments.

Therefore, there exists a long-felt need in the art for an improved paint pail liner that resists tearing, cracking, and premature wear during repeated use. There also exists a long-felt need in the art for a paint pail liner device that prevents paint from adhering to the interior surface, significantly simplifying the cleaning process. Moreover, there exists a long-felt need in the art for a paint pail liner that includes functional features such as a secure fit, drip control mechanisms, and compartments for tool organization to improve overall efficiency during painting.

The subject matter disclosed and claimed herein, in one embodiment thereof, comprises a paint pail liner device. The device is comprised of an improved paint pail liner comprising a flexible, durable silicone material with a non-stick coating to minimize paint adhesion and simplify cleaning. The liner body includes a molded lip for a secure fit around the pail rim, featuring an overhang to catch drips and optional pour spouts for controlled paint pouring. Integrated handle- shaped cutouts provide reinforced grip points for easy removal, while textured ridges on the interior surface facilitate uniform paint distribution across paint rollers. During use, the flexibility of the liner prevents cracking, supports extended use, and allows it to be turned inside out for thorough cleaning.

In this manner, the paint pail liner device of the present invention accomplishes all the forgoing objectives and provides a flexible, durable silicone liner body with a non-stick coating that prevents paint adhesion and allows easy removal of dried paint without scrubbing. The liner's flexibility enables it to be turned inside out for thorough cleaning, preventing structural failures such as cracking or tearing during repeated use. The molded lip ensures a secure, compression fit around the pail rim, preventing slipping or movement during application, while the drip-catching overhang reduces paint drips and waste. Additionally, the liner includes practical design features, such as a pour spout for controlled paint transfer, handle-shaped cutouts for easy removal, and textured ridges for uniform paint loading onto rollers.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a paint pail liner device comprising a flexible, durable silicone material designed to simplify paint application and cleaning. The liner body is comprised of a flexible, non-stick material, such as silicone, with an interior surface featuring a continuous non-stick coating that resists paint adhesion, allowing for easy removal of dried paint. The flexible liner body can be inverted for thorough cleaning, reducing the likelihood of cracks or tears during repeated use.

The liner body includes a molded lip configured to fit securely around the rim of a paint pail, providing a compression fit that prevents movement or slipping. A drip-catching overhang extends outward from the lip to capture paint drips, reducing mess and paint waste. In some embodiments, the overhang features a pour spout designed for controlled pouring, with contoured edges to minimize splatter during paint transfer.

Handle-shaped cutouts are integrated into the lip to facilitate easy removal of the liner from the pail. These cutouts are reinforced to maintain their structure during lifting, even when filled with paint. The interior surface of the liner features textured ridges to promote even loading of paint onto rollers, eliminating the need for a separate roller tray. The ridges can be arranged in various patterns to ensure uniform distribution and prevent paint pooling.

In some embodiments, the lip includes notched divots for securely holding paintbrushes, keeping handles elevated above the paint level. Additional molded fasteners, such as loops or hooks, may be provided to hold tools like paint rags or stir sticks. Embossed volume markings on the interior surface assist users in measuring paint quantities accurately, with markings in various units to suit user preferences.

The invention further includes a method of use where the liner is placed inside a paint pail with the molded lip secured around the rim. Paint is poured into the liner, and the textured ridges facilitate even paint loading onto brushes or rollers. After use, the liner is removed by gripping the handle-shaped cutouts and lifting upward. The flexible liner can be turned inside out for easy cleaning, exposing the non-stick surface for rinsing or wiping.

Accordingly, the paint pail liner device of the present invention is particularly advantageous as it provides a flexible, durable silicone liner body with a non-stick coating that prevents paint adhesion and allows easy removal of dried paint without scrubbing. The liner's flexibility enables it to be turned inside out for thorough cleaning, preventing structural failures such as cracking or tearing during repeated use. The molded lip ensures a secure, compression fit around the pail rim, preventing slipping or movement during application, while the drip-catching overhang reduces paint drips and waste. Additionally, the liner includes practical design features, such as a pour spout for controlled paint transfer, handle-shaped cutouts for easy removal, and textured ridges for uniform paint loading onto rollers. In this manner, the paint pail liner device overcomes the limitations of existing paint pail liners known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective top view of one potential embodiment of a paint pail liner device of the present invention in accordance with the disclosed architecture;

FIG. 2 illustrates a perspective side view of one potential embodiment of a paint pail liner device of the present invention before being inserted into a paint pail in accordance with the disclosed architecture; and

FIG. 3 illustrates a flowchart of a method of using one potential embodiment of a paint pail liner device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved paint pail liner that resists tearing, cracking, and premature wear during repeated use. There also exists a long-felt need in the art for a paint pail liner device that prevents paint from adhering to the interior surface, significantly simplifying the cleaning process. Moreover, there exists a long-felt need in the art for a paint pail liner that includes functional features such as a secure fit, drip control mechanisms, and compartments for tool organization to improve overall efficiency during painting.

The present invention, in one exemplary embodiment, is comprised of a paint pail liner device. The device is comprised of a flexible, durable silicone material designed to simplify paint application and cleaning. The liner body is comprised of a flexible, non-stick material, such as silicone, with an interior surface having a continuous non-stick coating that resists paint adhesion, enabling easy removal of dried paint. The flexible liner body can be inverted for thorough cleaning, reducing the risk of cracks or tears during repeated use.

The liner body includes a molded lip configured to fit securely around the rim of a paint pail, providing a compression fit that prevents movement or slipping. A drip-catching overhang extends outward from the lip to capture paint drips, minimizing mess and paint waste. In some embodiments, the overhang features a pour spout for controlled pouring, with contoured edges to reduce splatter during paint transfer.

Handle-shaped cutouts are integrated into the lip to facilitate easy removal of the liner from the pail. These cutouts are reinforced to maintain their structure during lifting, even when filled with paint. The interior surface of the liner features textured ridges that promote even paint loading onto rollers, eliminating the need for a separate roller tray. The ridges may be arranged in various patterns to ensure uniform distribution and prevent paint pooling.

In some embodiments, the lip includes notched divots for securely holding paintbrushes, keeping handles elevated above the paint level. Additional molded fasteners, such as loops or hooks, may be included to hold tools like paint rags or stir sticks. Embossed volume markings on the interior surface assist in measuring paint quantities accurately, with markings in various units to suit user preferences.

The invention further includes a method of use where the liner is placed inside a paint pail with the molded lip secured around the rim. Paint is poured into the liner, and the textured ridges facilitate even paint loading onto brushes or rollers. After use, the liner is removed by gripping the handle-shaped cutouts and lifting upward. The flexible liner can be inverted for easy cleaning, exposing the non-stick surface for rinsing or wiping.

Accordingly, the paint pail liner device provides a flexible, durable silicone liner body with a non-stick coating that resists paint adhesion and allows easy removal of dried paint without scrubbing. The liner's flexibility enables it to be inverted for thorough cleaning, preventing structural failures such as cracking or tearing during repeated use. The molded lip ensures a secure, compression fit around the pail rim, preventing slipping during use, while the drip-catching overhang reduces paint drips and waste. Additionally, the liner includes practical design features such as a pour spout for controlled paint transfer, handle-shaped cutouts for easy removal, and textured ridges for uniform paint loading onto rollers, addressing the limitations of existing paint pail liners.

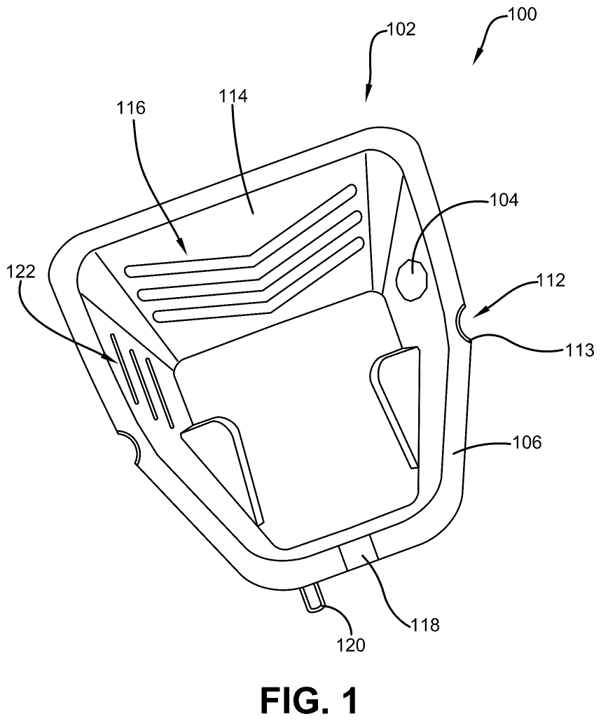

Referring initially to the drawings, FIG. 1 illustrates a perspective top view of one potential embodiment of a paint pail liner device 100 of the present invention in accordance with the disclosed architecture. The present invention relates to an improved paint pail liner comprising a flexible, durable silicone material. More specifically, the device 100 is comprised of a liner body 102 that is made from a flexible material, such as but not limited to silicone, that is non-stick or is comprised of a non-stick coating 104 to minimize paint adhesion, significantly simplifying the cleaning process. The non-stick coating 104 forms a continuous layer along the interior surface 114, preventing paint from forming a permanent bond with the liner and making even dried paint easy to remove without scrubbing. The non-stick coating 104 may be comprised of a material such as but not limited to polytetrafluoroethylene (PTFE), fluorinated ethylene propylene (FEP), silicone-based release coatings, or ceramic-reinforced polymers, all of which are selected for their durability, chemical resistance, and low-friction properties. Additionally, the body's 102 flexibility allows it to be turned inside out for thorough cleaning, further contributing to its extended operational life. This flexibility also prevents cracks or tears that may occur in rigid liners during repeated use or handling.

The body 102 is also comprised of a molded lip 106 that is configured to conform to or around the rim 12 of a paint pail 10, ensuring a secure compression fit that prevents any movement or slipping during use, even when the pail is being carried or tipped slightly during paint application. The molded lip 106 may include a drip-catching overhang 108, which extends outward and downward from the lip 106 to intercept and retain paint drips that occur when loading paint onto a brush or roller, thereby reducing mess and paint waste.

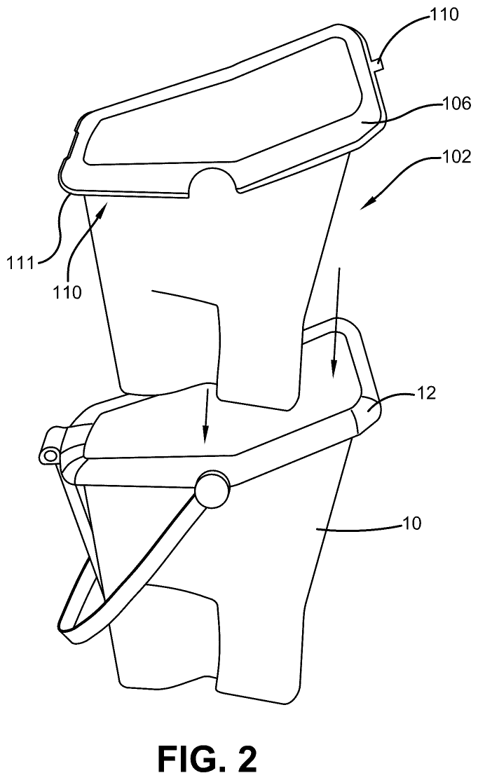

In one embodiment, the overhang 108 may incorporate a pour spout 110 at one or more strategically positioned locations along the lip 106, as seen in FIG. 2. The pour spout 110 is shaped to guide the paint flow in a concentrated stream, enabling controlled pouring of excess paint back into its original container. The edges 111 of the spout 110 are contoured to reduce paint splatter and dripping during the pouring process, ensuring a clean, efficient transfer of paint.

To facilitate easy removal of the device 100 from a paint pail 10, at least one handle-shaped cutout 112 is integrated into opposing sides of the lip 106, as seen in FIG. 1 and FIG. 2. The cutouts 112 may be any shape but are preferably circular or semi-circular to comfortably accommodate fingers or gripping tools. The cutouts 112 extend partially into the liner body 102 to provide a reinforced grip point without compromising the structural integrity of the lip 106. The edges 113 of the cutouts 112 may be reinforced to prevent the flexible silicone material from collapsing or folding inward during lifting, ensuring that the device 100 can be securely removed even when filled with paint.

The interior surface 114 of the liner body 102 includes multiple functional features designed to optimize the painting process. More specifically, the surface 114 is comprised of at least one textured ridge 116 (as seen in FIG. 1) that is preferably molded into the surface 114 to facilitate even loading of paint onto a roller and promote uniform distribution of paint across the roller, eliminating the need for a separate roller tray and contributing to a more efficient workflow. The ridge 116 may be in any shape and may be arranged in any pattern or orientation, such as but not limited to parallel, diagonal, or radial configurations. The height and spacing of the ridges 116 may be optimized to ensure that excess paint is evenly distributed and that no pooling occurs on the roller.

In one embodiment, at least one notched divot 118 is positioned along the lip 106 to provide dedicated resting points for paintbrushes. These divots 118 may be spaced to accommodate various brush sizes, ensuring that the brush handle remains elevated above the paint level. The depth and contour of the notches 118 are preferably configured to securely hold the brush without slipping, maintaining a cleaner workspace and ensuring that brushes remain easily accessible during use.

For added convenience, the lip 106 may include molded fasteners 120 such as but not limited to small loops or hooks designed to hold paint rags, stir sticks, or other commonly used tools. These molded fasteners 120 are integrally formed with the liner body 102 and are positioned to prevent interference with the painting process while keeping frequently used accessories within reach.

In some embodiments, the interior surface 114 may also include embossed volume markings 122 to assist users in accurately measuring paint quantities, making it easier to mix paint or prepare precise amounts for specific applications. The markings 122 may be presented in any measurement increment, such as but not limited to milliliters, ounces, or cups, to accommodate user preferences or specific requirements. These volume markings 122 are molded into the surface 114 to prevent wear and ensure long-term visibility even after repeated cleanings.

The improved paint pail liner described above provides enhanced durability, ease of use, and versatility, addressing common issues such as premature wear and paint adhesion seen in conventional liners. By utilizing a non-stick coating 104 made from advanced materials such as PTFE, FEP, or silicone-based coatings, the liner resists chemical degradation and supports longer-term use. The secure fit, drip-catching design, and functional interior features make the liner suitable for both professional and DIY applications, contributing to a cleaner, more efficient painting process.

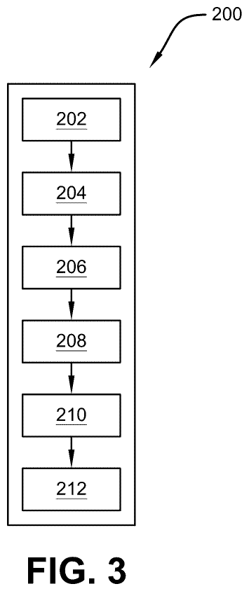

The present invention is also comprised of a method of using 200 the device 100, as seen in FIG. 3. First, a device 100 is provided, comprised of a liner body 102 comprised of at least one molded lip 106, at least one drip-catching overhang 108, and at least one interior surface 114 with textured ridges 116 [Step 202]. Then, the liner body 102 can be placed inside a paint pail 10 by securing the molded lip 106 around the rim 12 of the paint pail 10 to ensure a secure fit and prevent movement during use [Step 204]. Next, paint can be poured into the liner body 102, ensuring that the paint is evenly distributed across the interior surface 114 with the textured ridges 116 for optimal roller loading [Step 206]. A roller or brush can then be passed across the textured ridges 116 to load paint evenly onto the applicator, minimizing excess accumulation and promoting uniform paint distribution [Step 208]. After use, the liner body 102 can be removed from the paint pail 10 by gripping the handle-shaped cutouts 112 and lifting the liner upward, ensuring that the liner is securely detached from the pail rim 12 without spilling any remaining paint [Step 210]. The liner body 102 can then be turned inside out by folding the flexible material outward, exposing the interior surface 114 for cleaning [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “paint pail liner device” and “device” are interchangeable and refer to the paint pail liner device 100 of the present invention.

Notwithstanding the forgoing, the paint pail liner device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the paint pail liner device 100 as shown in the FIGS. are for illustrative purposes only, and that many other sizes and shapes of the paint pail liner device 100 are well within the scope of the present disclosure. Although the dimensions of the paint pail liner device 100 are important design parameters for user convenience, the paint pail liner device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paint pail liner device comprising:
a flexible liner body comprised of:
an interior surface comprised of a non-stick coating;
a lip; and
a cutout integrated into lip for gripping and removing the flexible liner body from a paint pail.

2. The paint pail liner device of claim 1, wherein the interior surface is comprised of a volume marking.

3. The paint pail liner device of claim 2, wherein the volume marking is comprised of a milliliter or an ounce.

4. The paint pail liner device of claim 1, wherein the lip is comprised of a molded lip that is molded from the flexible liner body.

5. The paint pail liner device of claim 1, wherein the cutout is comprised of a reinforced edge.

6. The paint pail liner device of claim 1, wherein the lip is comprised of a molded loop.

7. The paint pail liner device of claim 1, wherein the lip is comprised of a molded hook.

8. A paint pail liner device comprising:
a flexible liner body comprised of:
an interior surface comprised of a non-stick coating and a textured ridge;
a lip comprised of a drip-catching overhang; and
a cutout integrated into lip for gripping and removing the flexible liner body from a paint pail.

9. The paint pail liner device of claim 8, wherein the drip-catching overhang is comprised of a pour spout.

10. The paint pail liner device of claim 9, wherein the pour spout is comprised of a contoured edge.

11. The paint pail liner device of claim 8, wherein the drip-catching overhand is comprised of a notched divot.

12. The paint pail liner device of claim 8, wherein the textured ridge is arranged in a radial pattern across the interior surface.

13. The paint pail liner device of claim 8, wherein the textured ridge is arranged in a diagonal pattern across the interior surface.

14. The paint pail liner device of claim 8, wherein the textured ridge is arranged in a parallel pattern across the interior surface.

15. The paint pail liner device of claim 8, wherein the interior surface is comprised of a volume marking.

16. The paint pail liner device of claim 15, wherein the volume marking is comprised of a milliliter or an ounce.

17. The paint pail liner device of claim 8, wherein the cutout is comprised of a reinforced edge.

18. The paint pail liner device of claim 8, wherein the lip is comprised of a molded loop.

19. The paint pail liner device of claim 8, wherein the lip is comprised of a molded hook.

20. A method of using a paint pail liner device, the method comprising the following steps:
providing a paint pail liner device comprised of a liner body having a molded lip, an interior surface with a non-stick coating, and a handle-shaped cutout;
placing the liner body inside a paint pail by securing the molded lip around a rim of the paint pail to ensure a secure fit;
pouring a paint into the liner body, distributing the paint across a textured ridge of the interior surface;
passing a roller or brush across the textured ridge to load paint onto the roller or the brush;
removing the liner body from the paint pail by gripping the handle-shaped cutout and lifting the liner body upward; and
turning the liner body inside out for cleaning by folding the liner body outward.
